(19) United States
(12) Patent Application Publication
(10) Pub. No.: US 2008/0308563 A1
(43) Pub. Date: Dec. 18, 2008

(54) SUBCONTAINER TEMPERATURE REGULATING MECHANISM

(76) Inventor: Erik Overgaard, Oslo (NO)

Correspondence Address: SHERR & VAUGHN, PLLC, 620 HERNDON PARKWAY, SUITE 200, HERNDON, VA, 20170, US

(21) Appl. No.: 12/122,681

(22) Filed: May 17, 2008

Related U.S. Application Data
(60) Provisional application No. 60/938,483, filed on May 17, 2007.

(51) Int. Cl. A47J 41/00

(52) U.S. Cl. 220/592.17

(57) ABSTRACT

An apparatus including a container (e.g. a bottle, can, keg, box, etc.). The container may be configured to contain a consumable liquid. There may be at least one subcontainer inside the container. The subcontainer may include a temperature regulating mechanism that includes phase change material. Phase change material can maintain liquid (e.g. beer) in the container at a predetermined temperature (e.g. for beer, approximately 1-3 degrees Celsius) for a prolonged period of time.

Priority is claimed to U.S. Provisional Patent Application No. 60/938,483 (filed in the U.S. Patent and Trademark Office on May 17, 2007), which is herein incorporated by reference in entirety.

### BACKGROUND

Beverages are an important part of the lives of all humans. Since the beginning of the human race, humans have been consuming beverages (e.g. water, juices, and alcohol) for sustenance and enjoyment. Over time, beverages have been crafted and developed tailored to the tastes and nutritional requirements of a given society. Along with the development of beverages, consumption habits and preferences have been cultivated specific to different beverages. For example, different beverages may be optimally enjoyed at different temperatures. For example, beer may be ideally consumed between 1 degrees Celsius and 3 degrees Celsius.

It can be difficult to maintain beverages at its ideal serving temperature (e.g. 1-3 degrees Celsius for beer) for a reasonable amount of time. For example, beer consumed from an aluminum can, may be difficult to maintain at 1-3 degrees Celsius throughout the duration of consumption. Accordingly, there are challenges to maintaining beverages at their ideal serving temperature in a cost effective manner.

### SUMMARY

Embodiments relate to an apparatus including a container (e.g. a bottle, can, keg, box, etc.). The container may be configured to contain a consumable liquid. There may be at least one subcontainer inside the container. The subcontainer may include a temperature regulating mechanism that includes phase change material. In embodiments, phase change material can maintain liquid (e.g. beer) in the container at a predetermined temperature (e.g. for beer, approximately 1-3 degrees Celsius) for a prolonged period of time.

In embodiments, the at least one subcontainer includes at least one enclosure that encloses the phase change material. The enclosure may be of a material that is substantially thermally conductive (e.g. aluminum). In embodiments, the exterior shape of the enclosure is at least one of a cylinder, an envelope, a polyhedron, a sphere, or another similar shape

In embodiments, the at least one subcontainer includes a plurality of subcontainers. The plurality of subcontainers may be unattached from each other. In embodiments, the at least one subcontainer includes a plurality of subcontainers bonded together. In embodiments, the weight density of the at least one subcontainer is greater than the consumable liquid in the container.

In embodiments, beverages may be sold in a container that includes phase change material in integrated subcontainers. The subcontainers may enable the beverage to maintain an ideal serving temperature for a reasonable period of time. Accordingly, the consumption experience of the beverage may be enhanced by maintenance of an ideal serving temperature. In embodiments, subcontainers may be economically implemented in disposable beverage containers, allowing beverage manufacturers to provide beverages that have an enhanced consumption experience due to prolongation of an ideal serving temperate, without significant costs passed on to the consumer.

### DRAWINGS

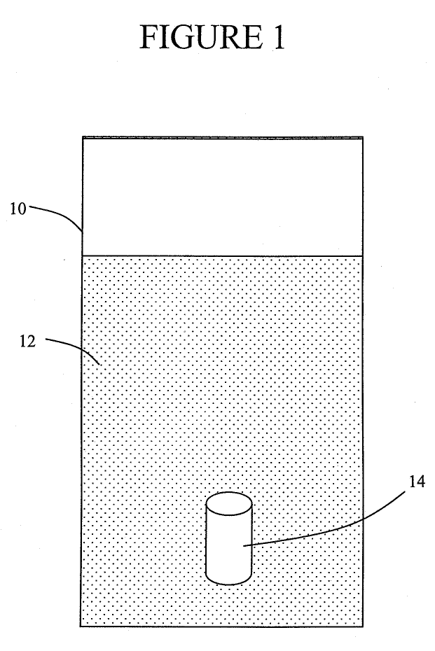

Example FIG. 1 illustrates a container with a cylindrical subcontainer, in accordance with embodiments.

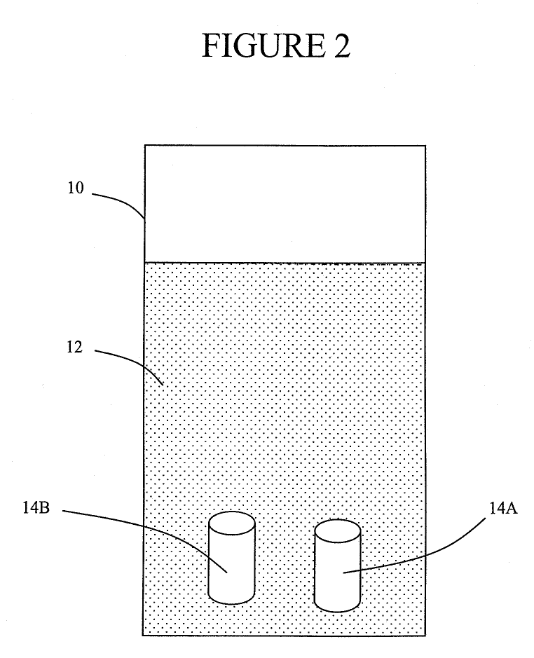

Example FIG. 2 illustrates a container with a plurality of unattached subcontainers, in accordance with embodiments.

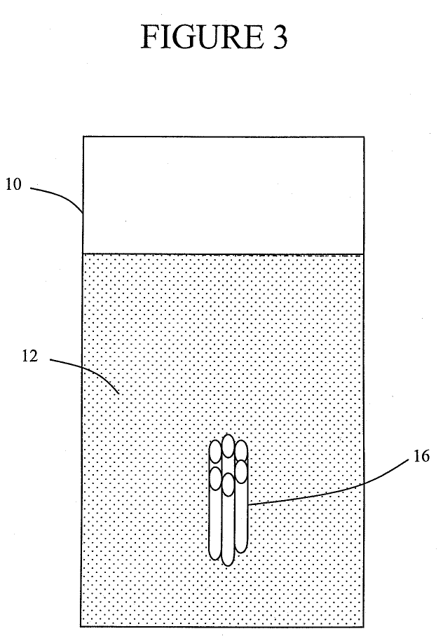

Example FIG. 3 illustrates a container with a plurality of bonded subcontainers, in accordance with embodiments.

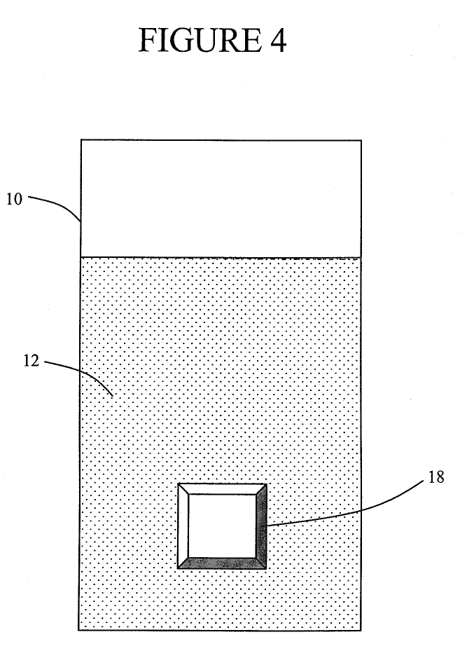

Example FIG. 4 illustrates a container with an envelope shaped subcontainer, in accordance with embodiments.

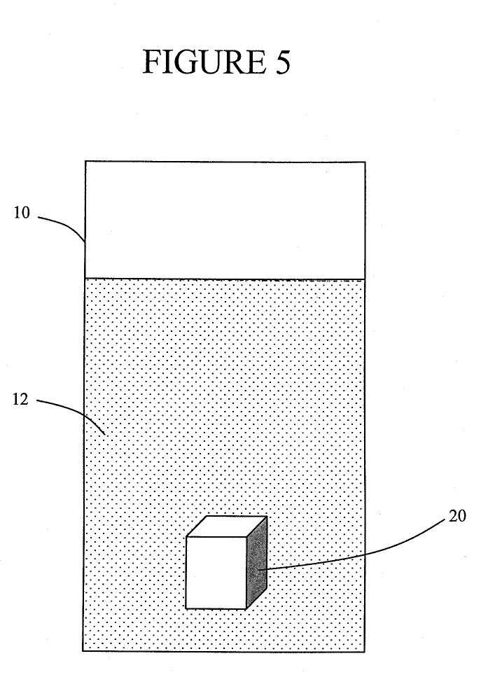

Example FIG. 5 illustrates a container with a polyhedron subcontainer, in accordance with embodiments.

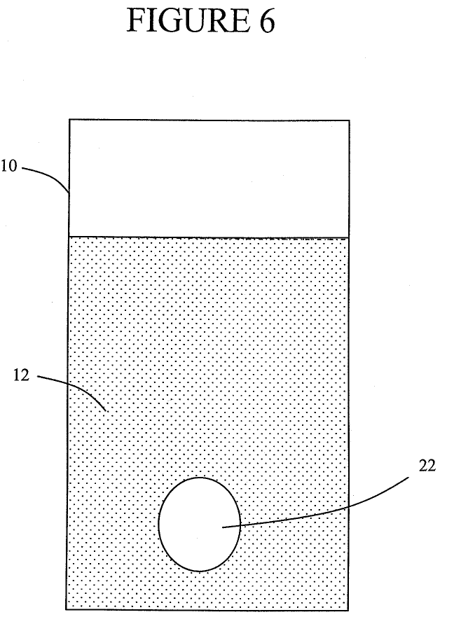

Example FIG. 6 illustrates a container with a spherical subcontainer, in accordance with embodiments.

### DESCRIPTION

Example FIG. 1 illustrates a container 10 with a subcontainer 14, in accordance with embodiments. Subcontainer 14 may be submerged in liquid 12 (e.g. a beverage). Subcontainer 14 may be loose inside container 10. In embodiments, subcontainer 14 may have a greater weight density than liquid 12. Accordingly, subcontainer 14 may be maintained towards the bottom of the container 10, so that it will not disturb consumption of the liquid 12 by interfering with an opening. In embodiments, subcontainer 14 may have a cylindrical shape.

Example FIG. 2 illustrates a container 10 with a plurality of unattached subcontainers 14A and 14B, in accordance with embodiments. Subcontainers 14A and 14B may be submerged in liquid 12 (e.g. a beverage), similar to subcontainer 14 illustrated in example FIG. 1. Although only two subcontainers 14A and 14B are illustrates in FIG. 2, any number of subcontainers may be implemented in embodiments. In embodiments, subcontainers 14A and 14B may be structurally independent from each other. In other embodiments, subcontainers 14A and 14B may be coupled to container 10.

Example FIG. 3 illustrates a container 10 with a plurality of bonded subcontainers 16, in accordance with embodiments. A plurality of subcontainers 16 may be bonded or attached together. Although example FIGS. 3 and 4 illustrate cylindrical subcontainers, other shapes of the subcontainers may be implemented, in accordance with embodiments.

Example FIG. 4 illustrates a subcontainer 18 having an envelope shape, in accordance with embodiments. Example FIG. 5 illustrates a subcontainer 20 having a polyhedron shape (e.g. a cube), in accordance with embodiments. Example FIG. 6 illustrates a subcontainer 22 having a spherical shape. One of ordinary skill in the art will appreciate other shapes that may be implemented for a subcontainer including PCM. In embodiments, the shape of a subcontainer may be configured to maximize the surface area of the subcontainer to maximize the thermal conduction between the PCM and the liquid of the container.

Embodiments relate to a container with a temperature regulating mechanism. In embodiments, a container configured to contain a beverage and/or liquid includes a temperature moderating or regulating mechanism to insulate, indicate and preserve a specific desired temperature level of a liquid.

Embodiments relate to a temperature moderating container which may be used to maintain a preferred temperature of contained beverages and/or liquids for storage, transport, serving, and consumption. A beverage and/or liquid container (e.g. bottle, box, can, keg and/or other container) may include a container (e.g. a subcontainer) inside the container that contains Phase Change Material (PCM). For example, a container that includes a PCM subcontainer may be a beer can. For example, a subcontainer may be a metal (e.g. aluminum) envelope that contains PCM. In embodiments, a PCM subcontainer may include a weighting mechanism to maintain the PCM subcontainer at the bottom of a host container.

Many spirits, wines and other beverages are best enjoyed in a tempered, chilled fashion. However, a too cold or near freezing temperature of the beverage or liquid may be undesirable from a consumption standpoint (e.g. an aromatic and/or organoleptic standpoint). For example, storage, transport or serving temperature that is too cold may either destroy or cause aroma elements vital to the full enjoyment of a wine, spirits or other beverage to deteriorate.

Embodiments use PCM to moderate and/or regulate the temperature of a beverage and/or liquid in a container. PCM may be tailor to a specific liquid to change phase and solidify like water freezes to ice from a liquid to a frozen stage at a specific desired temperature. This specific desire temperature may be between 1 and 12 degrees Celsius. However, other temperature ranges may be used. For beer, wines and spirits, a tailored temperature may correspond to an ideal or preferred serving or consumption temperature.

For many handheld beverage containers (e.g. aluminum cans, glass bottles, plastic bottles, and other handheld containers), the container may act as a heat sink from the warmth of the hand. Although the perception of a consumer holding a handheld beverage container is that their beverage is very cold because the container feels very cold, the beverage may actually be warming up at a relatively fast rate due to the thermal conductivity of the beverage container and the heat from the hand. From one perspective, the perception of a cold beverage is desirable for a beverage manufacturer to sell their “cold” beverages. From another perspective, the quick warming of the beverage may actually degrade the consumers experience because the beverage quickly warms up, which may ultimately be bad for a beverage manufacturer. However, a container with a PCM subcontainer may prolong the period of time that a beverage is maintained at an ideal cold serving temperature, while still creating the cold beverage container perception for the consumer.

In embodiments, when the temperature level of the liquid inside a container (e.g. with a PCM subcontainer inside the container) hits a specific point, corresponding with an optimum serving temperature, the PCM material inside the subcontainer may solidify and act as an insulator preventing the liquid inside to become too cold. Removed from a chilled storage and placed in a room temperature environment, the beverage and/or liquid may maintain and plateau at an ideal and/or desirable temperature for consumption. A container without a PCM subcontainer may not maintain an ideal serving temperature for a substantial and/or useful amount of time.

In embodiments, a PCM subcontainer may include a flexible or rigid enclosure than contains the PCM. A PCM subcontainer may be rigidly attached inside a beverage/liquid container or have freedom of movement inside a beverage/liquid container, in accordance with different embodiments. For example, a PCM subcontainer may be an envelope that is sealed with PCM inside. The PCM envelope may be made of a metal material (e.g. aluminum) or other material. The PCM subcontainer may be a flexible bag. The PCM subcontainer may have a rigid structure (e.g. a ball or cylinder or polyhedron). In embodiments, the walls of the subcontainer may be of a material with relatively high thermal conductivity, which may maximize the thermal conductivity between the beverage/liquid in the container and the PCM inside the PCM subcontainer. The PCM subcontainer may also contain a weight along with the PCM, so that the PCM subcontainer will always sink to the bottom of the liquid/beverage container. A weight may be in the form of pellets, balls, small particles, or relatively large structures that ensure that the PCM subcontainer will sink to the bottom of a liquid/beverage container, in accordance with embodiments. In embodiments, the walls of the PCM subcontainer may act as a weight to ensure that the PCM subcontainer sinks to the bottom of a liquid/beverage container.

In embodiments, a change of phase of liquid inside a PCM subcontainer that is inside a substantially transparent beverage/liquid container may act as a temperature indicator. A change of material phase corresponds with the ideal storage and/or serving temperature and thereby by visual inspection communicates that the liquid inside a beverage/liquid has reached a specific temperature level in a chilled storage. In embodiments, a PCM subcontainer may have substantially transparent walls, so that the PCM is visible from outside both the beverage/liquid container and a PCM subcontainer inside the beverage/liquid container.

Unlike water which solidifies at 0 degrees Celisius and expands, PCM material may solidify at a tailored temperature and/or may not expand. Accordingly, breakage of a container may be prevented and/or storage capacity of a container may be preserved, according to embodiments. Embodiments relate to a specific type of beverage (e.g. wine, beer, water, soda, juice, spirit, or other beverage) that can be preserved at a desired temperature.

“Phase Change Material” (PCM) specially formulated to fit the temperature maintenance requirement of a beverage contained within the container. The term “phase change material” is used to describe materials that use phase changes (e.g. melting or freezing) to absorb or release relatively large amounts of latent heat at relatively constant temperatures. Suitable PCM is available from Renewable Alternatives, LLC of Columbia, Mo. U.S. Pat. No. 6,574,971 to Suppes is hereby incorporated by reference in its entirety. PCMs allow for a micro encapsulation and a customized melt/freeze point. When the temperature becomes warmer than the freeze point, PCMs liquIfy and absorb and store heat. Conversely, when the temperature drops, the material will solidify and give off heat, warming the material coated or impregnated with PCM. PCM materials are used for a wide range of applications in the industry, and is far superior to and comparable with ordinary ice or freeze gel for many applications. For example, the U.S. army uses a cold vest filled with a PCM material to keep soldiers cool in hot conditions; the material interacts with body heath. PCM may be used as an insulator for Pizza delivery packaging to keep the pizza hot during transport. It may be used in air conditioning devices to accumulate cold in order to save electricity consumption.

In embodiments, PCM maintains beverages (e.g. alcohol and/or nonalcoholic) and/or liquids in a container at an ideal serving and/or consumption temperature. The PCM used may be non-toxic and may be made out of food grade materials such as soy. When the PCM is a solid and starts to melt to become a liquid, it may absorb large amounts of heat from its surroundings and thereby keep it cooler. Conversely when the PCM starts to go from a solid state to a liquid state it will release large amounts of heat and therefore aids in alcohol from getting too cold too quickly. It is the actual process of melting and freezing of the PCM that assists in temperature moderation.

The foregoing embodiments (e.g. a container with a subcontainer temperature regulating mechanism including phase change material) and advantages are merely examples and are not to be construed as limiting the appended claims. The above teachings can be applied to other apparatuses and methods, as would be appreciated by one of ordinary skill in the art. Many alternatives, modifications, and variations will be apparent to those skilled in the art.

What is claimed is:

1. An apparatus comprising:
a container configured to contain a consumable liquid; and
at least one subcontainer inside the container, wherein the subcontainer comprises a temperature regulating mechanism and the temperature regulating mechanism comprises phase change material.

2. The apparatus of claim 1, wherein the temperature regulating mechanism is configured to maintain the liquid at a predetermined temperature.

3. The apparatus of claim 2, wherein the predetermined temperature is below room temperature.

4. The apparatus of claim 2, wherein the liquid is beer and the predetermined temperature is between approximately 1 and 3 degrees Celsius.

5. The apparatus of claim 2, wherein the melting point of the phase change material is at approximately the predetermined temperature.

6. The apparatus of claim 1, wherein said at least one subcontainer comprises at least one enclosure that enclose the phase change material.

7. The apparatus of claim 6, wherein said at least one enclosure comprises material that is substantially thermally conductive.

8. The apparatus of claim 6, wherein the material that is thermally conductive is a metal.

9. The apparatus of claim 8, wherein the metal is aluminum.

10. The apparatus of claim 6, wherein said at least one enclosure has an exterior shape of a cylinder.

11. The apparatus of claim 6, wherein said at least one enclosure has an exterior shape of an envelope.

12. The apparatus of claim 6, wherein said at least one enclosure has an exterior shape of a polyhedron.

13. The apparatus of claim 6, wherein said at least one enclosure has an exterior shape of a sphere.

14. The apparatus of claim 1, wherein said at least one subcontainer is a single subcontainer.

15. The apparatus of claim 1, wherein said at least one subcontainer comprises a plurality of subcontainers bonded together.

16. The apparatus of claim 1, wherein the weight density of said at least one subcontainer is more than the consumable liquid.

17. The apparatus of claim 1, wherein said at least one subcontainer is loose inside the container.

18. The apparatus of claim 1, wherein the container is a bottle.

19. The apparatus of claim 1, wherein the container is a can.

20. The apparatus of claim 1, wherein the container is a beer keg.

21. The apparatus of claim 1, wherein the container is a beverage box.
